(19) United States
(12) Patent Application Publication
(10) Pub. No.: US 2014/0327595 A1
(43) Pub. Date: Nov. 6, 2014

(54) COMPOSITE RADOME WALL

(71) Applicants: Eelco Van Oosterbosch, Echt (NL); Lewis Kolak, Huntersville, NC (US); Chae Thompson, Mount Holly, NC (US); Andrew Beard, Stanley, NC (US)

(72) Inventors: Eelco Van Oosterbosch, Echt (NL); Lewis Kolak, Huntersville, NC (US); Chae Thompson, Mount Holly, NC (US); Andrew Beard, Stanley, NC (US)

(73) Assignee: DSM IP ASSETS B.V.., Heerlen (NL)

(21) Appl. No.: 14/239,857

(22) PCT Filed: Sep. 12, 2012
(86) PCT No.: PCT/EP2012/067813

§ 371 Date: Jul. 28, 2014

(30) Foreign Application Priority Data
Sep. 12, 2011 (EP) 11180893.7

(51) Int. Cl. H01Q 1/42; B32B 5/18; B32B 27/32; B32B 5/02

(52) U.S. Cl. CPC H01Q 1/422; B32B 5/024; B32B 5/18; B32B 27/32; B32B 2250/05; B32B 2250/40; B32B 2255/02; B32B 2307/20; B32B 2457/00
USPC 343/872

(57) ABSTRACT

The invention relates to a radome wall comprising a composite panel of a sandwich type containing two facings separated by a core of an expanded polymeric material wherein the facings contain a multi-layered sheet comprising a consolidated plurality of layers, said layers containing polymeric tapes.

The invention relates to a radome wall comprising a composite panel of a sandwich type containing two facings separated by a core of an expanded polymeric material. The invention also relates to a radome and a radar system comprising a radar antenna and the radome of the invention.

A radome is an electromagnetic cover for a radar system, i.e. a system comprising a radar antenna, and it is used to protect the system from environmental elements, such as shielding it for example against wind and rain. An important requirement of a radome is that the radome does not substantially adversely affect a radar wave, which passes through the radome; but also when a reflected radar wave enters back through the radome to be received by the radar antenna. Therefore, the radome should in principle have two primary qualities: sufficient structural integrity and durability for the environmental elements and adequate electromagnetic performance providing a satisfactory transmission efficiency of radar waves thorough the radome.

The electromagnetic performance of a radome is typically measured by a radome's ability to minimize reflection, distortion and attenuation of radar waves passing through the radome in a direction. The transmission efficiency is analogous to the radome's apparent transparency to the radar waves and is expressed as a percent of the radar's transmitted power measured when not using a radome cover on the system. As radomes can be considered as electromagnetic devices, tuning the radome can optimize transmission efficiency. The tuning of a radome is managed according to several factors, including thickness of the radome wall and the composition thereof. For example by carefully choosing materials having a determined dielectric constant and loss tangent, each of which being a function of the wave frequencies transmitted or received by the radar system, the radome can be tuned. A radome which is poorly tuned will attenuate, scatter, and reflect the radar waves in various directions, having deleterious effect on the quality of the radar signal.

One prior art radome wall, which has been found to perform well, is referred to as an A-sandwich construction. An A-sandwich radome wall contains a composite panel containing an expanded core, e.g. a honeycomb or a foam-containing core, bounded by facings usually containing an epoxy/fiberglass laminate. The thickness of the entire sandwich construction, core and facings, is approximately a quarter wavelength thick for near incidence angles of radar waves. Such A-sandwich radome walls are disclosed for example by EP 0 843 379; EP 0 359 504; EP 0 470 271; GB 633,943; GB 821,250; GB 851,923; U.S. Pat. No. 2,659,884; U.S. Pat. No. 4,980,696; U.S. Pat. No. 5,323,170; U.S. Pat. No. 5,662,293; U.S. Pat. No. 6,028,565; U.S. Pat. No. 6,107,976; and US 2004/0113305.

A-sandwich radome walls containing facings comprising synthetic fibers are known for example from U.S. Pat. No. 3,002,190, example of synthetic fibers being polyethylene fibers such as in U.S. Pat. No. 5,182,155 and aramid fibers such as in U.S. Pat. No. 5,408,244.

Other examples of sandwich radome walls include the B, C and D sandwiches. For example a C-sandwich radome wall comprises a core bounded by two facings, which themselves are bounded by yet another layers of the material of the core. Other such constructions are shown in U.S. Pat. No. 4,613,350; U.S. Pat. No. 4,725,475; U.S. Pat. No. 4,677,443; U.S. Pat. No. 4,358,772 and U.S. Pat. No. 3,780,374.

It was observed that although the known sandwich-type, also often referred to as composite, radome walls have most of the times a satisfactory electromagnetic performance, this performance may be improved. For instance none of such composite radome walls have an electromagnetic performance that would enable the manufacturing of an effective radome for antennas operating at ultra-high frequencies, e.g. at the GHz level such as higher than 50 GHz and even higher than 70 GHz. When using known composite radome walls for an ultra-high frequency antenna, it was observed that the antenna may have a short operating range and its power had to be drastically increased to compensate for any signal loss. Increasing the antenna's power may in turn reduce the antenna's operating lifetime and also increases the operating cost due to high electricity consumption.

An object of the invention may thus be to provide a composite radome wall which would enable the manufacturing of an efficient broadband radome, i.e. a radome which shows a good electromagnetic transparency over a large bandwidth and in particular in the microwave bandwidth, e.g. for frequencies up to 140 GHz and more in particular for frequencies between 1 GHz and 130 GHz.

The invention provides a radome wall comprising a composite panel of a sandwich type containing two facings separated by a core of an expanded polymeric material wherein the facings contain a multi-layered sheet comprising a consolidated plurality of layers, said layers containing polymeric tapes.

It was observed that the radome wall of the invention has satisfactory electromagnetic performance for a broad range of frequencies. In particular it was observed that said radome wall may have good performance for X-band operating radars and may also perform well for W- and/or F-band operating radars. For clarity, by X-, W- and F-bands are herein understood the frequency ranges of between 8 and 12 GHz, 75 and 110 GHz and 90 and 140 GHz, respectively. In addition to the above mentioned advantages, the radome wall of the invention may have unmatched electromagnetic performance at discrete frequencies within the above mentioned ranges as it will become apparent to those skilled in the art upon reference to the detailed description presented hereinafter. Also the radome wall of the invention shows good mechanical properties such as strength, stiffness and kinetic energy absorption.

It is known to use polymeric tapes in manufacturing radome walls for example from WO 2010/122099. However, this publication aims in replacing the known composite radome walls, i.e. walls comprising a core and facings such as the one of the invention or the one described in U.S. Pat. No. 5,182,155, with single-layer walls, i.e. walls made of a single material since such single-layer walls may be easier to build and maintain and may have a better structural stability.

By tape is herein understood an elongated body having a length dimension, a width dimension and a thickness dimension, wherein the length dimension of the tape is greater than its width dimension, and wherein said length dimension is much greater than its thickness dimension. It is preferred however not mandatory that the tapes used in accordance with the invention are non-fibrous tapes, i.e. tapes obtained with a process different than a process comprising a step of producing fibers and a step of using, e.g. fusing, the fibers to make a tape. The tapes used in the present invention are preferably solid-state tapes, i.e. tapes obtained by compressing a polymeric powder bed and further calendering and/or drawing the compressed powder bed. The tape preferably has a thickness of between 1 μm and 200 μm and more preferably of between 5 μm and 100 μm. Preferably, the tape has a width of between 20 mm and 2000 mm, more preferably between 50 mm and 1500 mm, most preferably between 80 mm and 1200 mm. Said tape preferably has an average thickness of between 5 μm and 400 μm, more preferably between 7.5 μm and 350 μm, most preferably between 10 μm and 300 μm. By width of a tape is herein understood the largest distance measured between two points on the perimeter of a cross-section of said tape. By thickness of a tape is herein understood the largest distance measured between two opposite points on the perimeter of a cross-section of said tape, wherein the distance used for measuring said thickness is perpendicular on the distance used for measuring the width of the tape. Preferably, said tape has a width (W) to average thickness (T) ratio (W/T) of at most 40.000, more preferably at most 30.000, most preferably at most 25.000. Preferably, said tape has a width (W) to average thickness (T) ratio (W/T) of at least 20, more preferably of at least 60, most preferably of at least 100. In an embodiment said tape has an areal density of preferably at most 160 g/m², more preferably at most 70 g/m², most preferably at most 40 g/m².

A tape as defined in accordance with the invention is structurally different than the fibers contained by the facings of the radome walls of the prior art. Said fibers are elongated bodies having an oval or circular cross-section wherein the ratio of the highest dimension of said cross-section to the lowest dimensions thereof is at most 5.

By polymeric tape is herein understood a tape manufactured from a polymeric material, suitable examples of polymeric materials including, but not being limited thereto, polyamides and polyaramides, e.g. poly(p-phenylene terephthalamide); poly(tetrafluoroethylene) (PTFE); poly(p-phenylene-2,6-benzobisoxazole) (PBO); liquid crystalline polymers (LCP), e.g. Vectran® (copolymers of para hydroxybenzoic acid and para hydroxynaphtalic acid); poly{2,6-diimidazo-[4,5b-4′,5′e]pyridinylene-1,4(2,5-dihydroxy)phenylene}; poly(hexamethyleneadipamide) (known as nylon 6,6), poly(4-aminobutyric acid) (known as nylon 6); polyesters, e.g. poly(ethylene terephthalate), poly(butylene terephthalate), and poly(1,4 cyclohexylidene dimethylene terephthalate); polyolefins, e.g. homopolymers and copolymers of polyethylene and polypropylene; but also polyvinyl alcohols and polyacrylonitriles.

Very good results were obtained when the polymeric tapes used in accordance with the invention were polyolefin tapes. Even better results were obtained when said tapes were tapes of polyethylene, more preferably of ultra high molecular weight polyethylene (UHMWPE). The preferred UHMWPE has an intrinsic viscosity (IV) of preferably at least 2 dl/g, more preferably at least 3.5 dl/g, most preferably at least 5 dl/g. Preferably the IV of said UHMWPE is at most 40 dl/g, more preferably at most 25 dl/g, more preferably at most 15 dl/g. Preferably, the UHMWPE has less than 1 side chain per 100 C atoms, more preferably less than 1 side chain per 300 C atoms. A further preferred UHMWPE has a weight average molecular weight (Mw) of at least 100.000 g/mol, preferably also having a Mw/Mn ratio of at most 6, wherein Mn is the number averaged molecular weight. Suitable methods for manufacturing polyethylenes can be found for example in WO 2001/021668 and US 2006/0142521 included herein by reference. A particularly preferred UHMWPE is a highly disentangled UHMWPE obtainable according to a process using the conditions described in WO 2010/007062 pg. 17 and 18, included herein by reference.

Polymeric tapes may be produced by feeding the polymeric material to an extruder, extruding a tape at a temperature of preferably above the melting point of the polymeric material and drawing the extruded tape. If desired, prior to feeding the polymeric material to the extruder, said material may be mixed with a suitable solvent, for instance to form a gel, such as is preferably the case when using high molecular weight polymers. In particular the manufacturing of UHMWPE tapes is described in various publications, including EP 0 205 960 A, EP 0213208 A1, U.S. Pat. No. 4,413,110, WO 01 73173 A1, and Advanced Fiber Spinning Technology, Ed. T. Nakajima, Woodhead Publ. Ltd (1994), ISBN 1-855-73182-7, and references cited therein, all incorporated herein by reference. In these publications, UHMWPE tapes are made by a gel spinning process and have favorable mechanical properties, e.g. a high modulus and a high tensile strength. Preferably the UHMWPE tapes are manufactured according to a gel spinning process as described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7. To produce tapes, the above processes may be routinely adapted by using spinning dyes having spinning slits instead of spinning holes.

In a preferred embodiment the tapes used in accordance to the invention, are made by a process comprising step a) feeding a polymeric powder bed between a combination of endless belts and compression-moulding the powder bed between pressuring means at a temperature below the melting point of the polymeric powder; step b) conveying the resultant compression-moulded powder between calendar rolls to form a tape; and step c) drawing the tape. Preferably, the polymeric material used is a polyolefin, more preferably an UHMWPE. Tapes obtained by a process in accordance with such an embodiment are commonly referred to in the art as solid-state tapes.

According to the invention, the layers used to manufacture the multi-layer sheets comprise polymeric tapes. Preferably said layers are matrix-free layers, i.e. layers substantially free of any binder, adhesive or other material used for stabilizing said layer. Preferably, said layers consist essentially of polymeric tapes, more preferably, said layers consist of polymeric tapes.

In one embodiment, the polymeric tapes form a unidirectional fabric. By unidirectional fabric of polymeric tapes is herein understood a fabric wherein the tapes are unidirectionally aligned and run along a common direction with their lengths defining and being contained by a single plane. A gap may exist between two adjacent tapes, said gap being preferably at most 10%, more preferably at most 5%, most preferably at most 1% of the width of the narrowest of said two adjacent tapes. Preferably, the tapes are in an abutting relationship. More preferably, the fabric comprises adjacent tapes that overlap each other along their length over part of their surface, preferably the overlapping part being at most 50%, more preferably at most 25%, most preferably at most 10% of the width of the narrowest of said two overlapping adjacent tapes. Preferably, the running common direction of the tapes in a layer is under an angle with the running common direction of the tapes in an adjacent layers, said angle being preferably between 45° and 90°, more preferably about 90°.

Very good results are obtained when the polymeric tapes form a woven fabric. Preferred woven structures are plain weaves, basket weaves, satin weaves and crow-foot weaves. Most preferred woven structure is a plain weave. Preferably, the thickness of a woven fabric is between 1.5 times and 3 times the thickness of a tape, more preferably about 2 times the thickness of a tape.

In one embodiment, at least part of the layers used to manufacture the multi-layer sheets comprise a single tape having a length and a width about the same as the length and width of the sheet. Hereinafter, for the purpose of this embodiment such a tape is referred to as film. The dimensions of width and length of the film are thus dependant on the dimensions of the sheet, which in turn are dependant on its application. The skilled person can routinely determine the lateral dimensions of said film. Preferably said film is anisotropic. By anisotropic is meant in the context of the present invention that two mutually perpendicular directions can be defined in the plane of the film for which the modulus of elasticity in a first direction is at least 3 times higher than the modulus of elasticity in the direction perpendicular to it. Generally the first direction of an anisotropic film is in the art also referred to as machine direction or drawing direction (or as direction of orientation) having the highest mechanical properties. Very good results were obtained when the monolayers containing the film were stacked such that the directions of orientation, i.e. the machine directions, of the films in two adjacent monolayers is under an angle α of preferably between 45 and 135°, more preferably between 65 and 115° and most preferably between 80 and 100°. A method of preparing such anisotropic films is disclosed for example in WO2010/066819, which is incorporated herein by reference.

According to the invention, the facings contain a multi-layered sheet comprising a consolidated plurality of layers. The skilled person knows how to consolidate a plurality of layers, for examples by compressing a stack of layers at increased temperatures, usually below the melting temperature of the polymeric tapes contained by said layers. Preferably said multi-layered sheet is a matrix-free multi-layered sheet. Preferably, said multi-layered sheet has outer surfaces defining a sheet volume (Vs), wherein said volume consists essentially of polymeric tapes. Said sheet may however, contain coatings covering at least one of the outer surfaces.

It was observed that a radome wall of high quality was obtained when the multi-layered sheet was obtained by a process comprising the steps of:
a) providing a plurality of layers comprising polymeric tapes;
b) providing at least one pre-formed polymeric film;
c) stacking the plurality of layers to obtain a stack of layers, said stack having an upper surface and a lower surface, which is opposite to the upper surface, and placing the at least one pre-formed polymeric film at least on the upper surface to create an assembly containing said stack and said pre-formed polymeric film;
d) compressing the assembly of step c) at a pressure of at least 100 bars and at a temperature of less than the melting temperature of the polymeric tapes, for a dwell time;
e) cooling the assembly to below 70° C., preferably to room temperature, followed by releasing the pressure; and
f) removing the pre-formed polymeric film from the assembly.

According to step b) of the process of the invention, at least one pre-formed polymeric film is provided. Pre-formed polymeric films manufactured from various polymeric materials can be used according to the process of the invention. In one embodiment, said pre-formed polymeric film is manufactured from a polymeric material that is different, i.e. it belongs to a different polymeric class, than the polymeric material used to manufacture the polymeric tapes contained by the layers.

Preferred polymeric materials for manufacturing the pre-formed polymeric films used in accordance to the process of the invention include polyvinyl-based materials, e.g. polyvinyl chloride, and silicone-based materials. Good results may be obtained when the pre-formed polymeric films are films manufactured from polyvinyl chloride or silicon rubber.

The thickness of the pre-formed polymeric film is preferably at least 50 μm, more preferably at least 100 μm, most preferably at least 150 μm. Preferably, the thickness of the pre-formed polymeric film is between 100 μm and 25 mm, more preferably between 200 μm and 20 mm, most preferably between 300 μm and 15 mm. For example, for silicon rubber films most preferred thicknesses are between 500 μm and 15 mm, while for polyvinyl chloride films most preferred thickness are between 1 mm and 10 mm. Silicon rubber and polyvinyl chloride films having a wide range of thicknesses are commercially available and may be obtained e.g from Arlon (US) and WIN Plastic Extrusion (US), respectively.

It was observed that good results may be obtained when the pre-formed polymeric film has a tensile strength of at least 3 MPa. Preferably, the tensile strength of the pre-formed polymeric film is at least 9 MPa, more preferably at least 15 MPa, even more preferably at least 19 MPa. In case a polyvinyl chloride film is used as the pre-formed polymeric film, said polyvinyl chloride film preferably has a tensile strength of between 10 MPa and 25 MPa, more preferably of between 13 MPa and 22 MPa, most preferably of between 16 MPa and 20 MPa. In case a silicon rubber film is used as the pre-formed polymeric film, said silicon rubber film preferably has a tensile strength of between 3 MPa and 20 MPa, more preferably of between 5 MPa and 17 MPa, most preferably of between 7 MPa and 15 MPa.

The temperature during the compression step d) is generally controlled through the press temperature or if a mould is used, through the mould temperature and can be measured with e.g. thermocouples placed between the layers. The temperature during the compression step d) is preferably chosen below the melting temperature (Tₘ) of the polymeric tapes as measured by DSC. In case the assembly contains more than one type of polymeric tapes, by melting temperature is herein understood the lowest melting temperature of the more than one type of polymeric tapes. Preferably the temperature during the compression step d) is at most 20° C., more preferably at most 10° C. and most preferably at most 5° C. below the melting temperature of the polymeric tapes. For example, in the case of polyethylene tapes and more in particular in case of UHMWPE tapes, a temperature for compression of preferably between 135° C. and 150° C., more preferably between 145° C. and 150° C. may be chosen. The minimum temperature generally is chosen such that a reasonable speed of consolidation is obtained. In this respect 50° C. is a suitable lower temperature limit, preferably this lower limit is at least 75° C., more preferably at least 95° C., most preferably at least 115° C.

The facings contained by the radome wall of the invention may also contain a coating, e.g. epoxy resins, cyanate Ester, PTFE, and polybutadiene. Before coating, said facings may also be primed with e.g. an epoxy primer or other primer suitable for the coating that is used. Suitable thicknesses for the primer are from 0.02 to 1.0 mils (0.5 to 25.4 μm), preferably from 0.05 to 0.5 mils (1.3 to 12.7 μm), most preferably from 0.05 to 0.25 mils (1.3 to 6.4 μm).

Preferably, each facing has an areal density (AD) of at least 100 kg/m², more preferably of at least 200 kg/m², most preferably of at least 300 kg/m².

According to the invention, a core of an expanded polymeric material is contained between the two facings. By expanded polymeric material is herein understood a material having a density that is lower than the intrinsic density of the polymeric material used to manufacture said expanded polymeric material. Preferred examples of expanded polymeric materials are polymeric foams and polymeric honeycombs.

In a preferred embodiment, the expanded polymeric material is a polymeric foam. Suitable polymeric materials for manufacturing such foams are thermoplastic and thermosetting materials, examples thereof including polyisocyanates, polystyrene, polyolefins, polyamides, polyurethanes, polycarbonates, polyacrylates, polyvinyls, polyimides, polymethacrylimides and blends thereof but also other synthetic materials such as rubbers and resins. Suitable examples of preferred polymeric materials include polyethylene terephthalate (PET), polyetherimide (PEI), meta-aramids, epoxy resins, cyanate ester, PTFE, and polybutadiene. A particular example of a foam is a syntactic foam, i.e. a foam containing glass microballoons. Such foams are known in the art, specific examples thereof being given in the above-mentioned publications. Preferably, the polymeric foam is a closed-cell foam, i.e. a foam wherein most cells, preferably all cells, are entirely surrounded by a cell wall. Preferably said foam has cells having a diameter in the range between 1 μm and 80 μm, more preferably between 5 μm and 50 μm, most preferably between 10 μm and 30 μm Preferably said foam has a density of between 20 and 220 kg/m³, more preferably of between of between 50 and 180 kg/m³, most preferably of between of between 110 and 140 kg/m³. Preferably, the foam has a dielectric constant of at most 1.40, more preferably of at most 1.15, most preferably of at most 1.05. Preferably the foam has a compressive modulus as measured in accordance with ASTM D1621 of 13.000 psi, more preferably of 15.000 psi, most preferably of 25.000 psi.

In another embodiment, the expanded polymeric material is an open-cell foam or a honeycomb. A common characteristic thereof is that both these types of expanded materials have cells not completely surrounded by a cell wall.

According to the invention, the radome wall comprises a composite panel of a sandwich type. Said panel contains two facings separated by the core of the expanded polymeric material. A preferred method for making such a sandwich type panel may comprise the steps of:
i. providing at least two multi-layered sheets comprising a consolidated plurality of layers, wherein said layers contain polymeric tapes;
ii. providing an expanded polymeric material;
iii. using the at least two sheets as facings and the expanded polymeric material as core to obtain a sandwich type structure comprising the two facings and said core, wherein the core is placed between said facings; and
iv. compressing said sandwich type structure at elevated pressure and temperature to obtain a sandwich type panel.

Preferably, the sandwich type structure is compressed at a pressure of at least 500 psi, more preferably of at least 700 psi, most preferably of at least 1000 psi. Preferably, said structure is compressed at a temperature of below both the melting temperatures as measured by DSC of the polymeric tapes and of the expanded polymeric material. Preferably, said temperature is at most 135° C.

To enhance the adhesion of the facings to the core, an adhesive layer can be used between each facing and the core. Preferred adhesives include those based upon polyolefins or modified polyolefins such as those known as Nolax, Exact, Spunfab and LDPE. It was observed that by using such polyolefin based adhesives, radome walls having good properties were obtained. Other suitable adhesives may be those based upon polyamides, polyesters, and urethanes but also those based upon various elastomers.

Most preferred adhesive is a plastomer containing a semi-crystalline copolymer of ethylene or propylene and one or more C2 to C12 α-olefin co-monomers and wherein said plastomer has a density as measured according to ISO1183 of between 870 and 930 kg/m³. Said plastomer is a plastic material that belongs to the class of thermoplastic materials. Preferably, the plastomer is manufactured by a single site catalyst polymerization process, preferably said plastomer being a metallocene plastomer, i.e. a plastomer manufactured by a metallocene single site catalyst. Ethylene is in particular the preferred co-monomer in copolymers of propylene while butene, hexene and octene are being among the preferred α-olefin co-monomers for both ethylene and propylene copolymers. In a preferred embodiment, the plastomer is a thermoplastic copolymer of ethylene or propylene and containing as co-monomers one or more α-olefins having 2-12 C-atoms, in particular ethylene, isobutene, 1-butene, 1-hexene, 4-methyl-1-pentene and 1-octene. When ethylene with one or more C3-C12 α-olefin monomers as co-monomers is applied, the amount of co-monomer in the copolymer usually is lying between 1 en 50 wt. %, and preferably between 5 and 35 wt. %. In case of ethylene copolymers, the preferred co-monomer is 1-octene, said co-monomer being in an amount of between 5 wt % and 25 wt %, more preferably between 15 wt % and 20 wt %. In case of propylene copolymers, the amount of co-monomers and in particular of ethylene co-monomers, usually is lying between 1 en 50 wt. %, and preferably between 2 and 35 wt %, more preferably between 5 and 20 wt. %. Good results were obtained when the density of the plastomer is between 880 and 920 kg/m³, more preferably between 880 and 910 kg/m³.

The sandwich type panels may be cut to their desired shape preferably with a water-jet or laser cutting device.

It was observed that the inventive radome walls have unique electromagnetic properties and may offer a higher freedom to designing various radome constructions, freedom seldom, if never, offered by the known materials hitherto. Especially for ultra-high frequencies, e.g. frequencies of above 50 GHz and even above 70 GHz, the inventive radome walls offer a unique performance. In particular at ultra-high frequencies, the materials of the invention show significantly reduced multi reflections or resonances as compared with known materials, which otherwise would amplify any signal noise to the extent that the operation of an antenna protected thereby may be seriously impaired. It was observed that the signal to noise ratio for the inventive radome walls when used in radomes is good which increases the efficiency of a radome-antenna system.

The invention relates further to radomes comprising any one of the inventive radome walls. It was observed that said walls are suitable for use in radomes designed for a variety of applications.

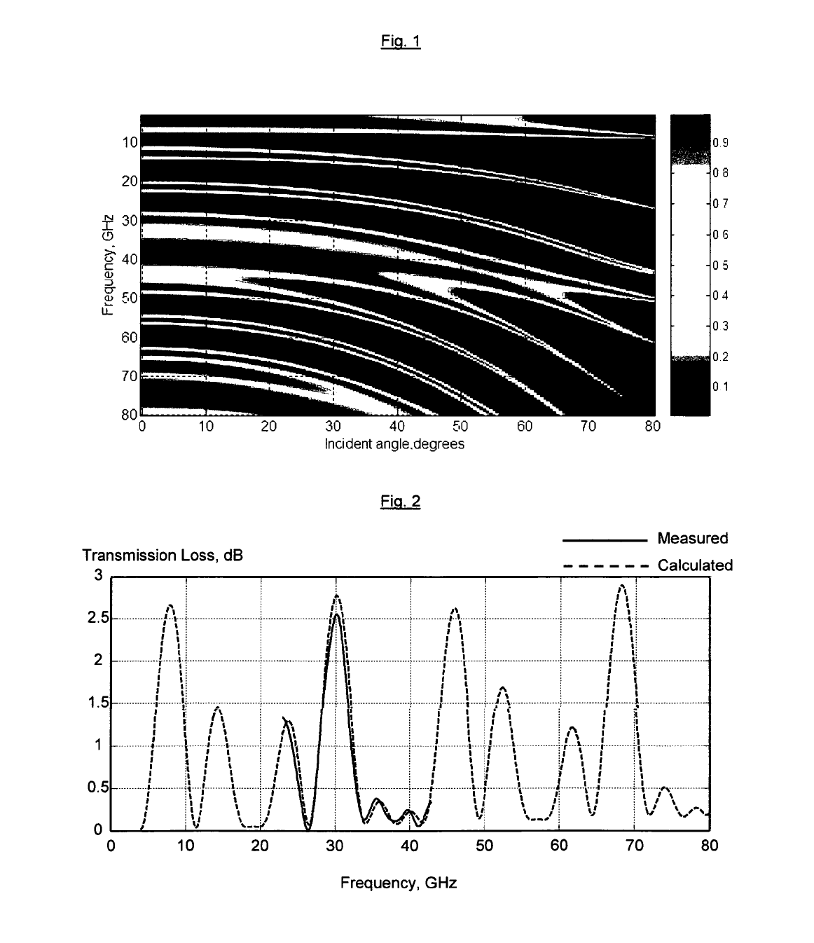

In particular the invention relates to a radome comprising a geodesic structure, said structure comprising the radome walls of the invention. A radome comprising a geodesic structure is known for example from U.S. Pat. No. 4,946,736 (see FIG. 2 therein and description thereof) the disclosure of which is incorporated herein by reference. Other common designs of geodesic structures may include an “Igloo” shaped structure. It was observed that the inventive radome walls have sufficient mechanical properties to enable the manufacturing of such radomes.

The invention also relates to an aircraft comprising a radome, said radome containing the inventive radome wall. It was observed that the inventive radome walls have properties making them useful as structural components in an aircraft, for example they can be used to form an aperture seal for an opening in a fuselage skin of the aircraft, wherein an antenna is located within said opening. A similar radome configuration is exemplified in U.S. Pat. No. 4,677,443 the disclosure of which is herein included by reference.

The invention also relates to a structural component in airborne, land and sea applications devices, said component comprising the radome wall of the invention. It was observed that said components of the invention have good structural properties.

The invention also relates to a radome containing the inventive radome wall wherein the radome is adapted for an array antenna, e.g. a phased array antenna. A design of a radome adapted for an array antenna is disclosed in U.S. Pat. No. 4,783,666 included herein by reference and more in particular in the Figures and figures' explanations thereof. A further design of such a radome is disclosed in U.S. Pat. No. 5,182,155 included herein by reference. It was observed that for such an array antenna the inventive radome walls enable the manufacturing of a radome having good electromagnetic as well as mechanical properties.

The invention further relates to a radome containing a spherical structure or a part of a spherical structure, said structure containing at least one spherical element, preferably containing a plurality of partly spherical elements, said at least one element comprising the inventive radome wall. A method for constructing such a structure is described in U.S. Pat. No. 5,059,972, the disclosure of which being included herein by reference. It was observed that the inventive radome walls enable the construction of spherical radomes suitable for enclosing large antennas in particular those used for monitoring weather disturbances.

The invention further relates to a radome for protection from atmospheric influences said radome comprising a folding rigid structure said structure comprising the inventive radome wall wherein the radome preferably further comprises a flexible roofing. Such a radome construction is known for example from U.S. Pat. No. 4,833,837 included herein by reference.

The invention also provides a radome adapted to cover a radar antenna for an aircraft, ship or other radar installation, said radome comprising the inventive radome wall.

The invention further relates to a radome-antenna system comprising a radome containing the inventive radome wall and an antenna device. Preferably, the antenna device is chosen from the group consisting of an antenna array; a microwave antenna; a dual or multiple frequency antenna preferably operating at frequencies above 39.5 GHz; a radar antenna; a planar antenna; and a broadcast antenna.

By antenna is understood in the present invention a device capable of emitting, radiating, transmitting and/or receiving electromagnetic radiation. Examples of typical antennas include air surveillance radar antennas and satellite communication station antennas.

The invention also relates to a method of transmitting and/or receiving electromagnetic waves, wherein the inventive radome wall is placed in the path of said electromagnetic waves. For example a protective structure comprising the radome wall of the invention is utilized to house and/or protect lasers, masers, diodes and other electromagnetic wave generation and/or receiving devices. In one particular embodiment, a protective structure as herein described is utilized in conjunction with devices operating with radio frequency waves such as those between about 1 GHz and 130 GHz, preferably between about 1 GHz and 100 GHz, more preferably between 1 GHz and 72 GHz. Protective structures could be useful for protecting electrical equipment used to monitor parts of a human or animal body or organs thereof, to monitor weather patterns, to monitor air or ground traffic or to detect the presence of aircraft, boats or other vehicles around e.g. military facilities including warships.

Figure represents a typical electromagnetic response of a radome wall according to the invention.

The invention will be further described with the help of the following examples and comparative experiments, without being however limited thereto.

### Methods of Measuring

Flexural strength and modulus of a sample (facing or core) is measured according to ASTM D790-07. To adapt for various thicknesses of the sample, measurements are performed according to paragraph 7.3 of ASTM D790-07 by adopting a loading and a support nose radius, which are twice the thickness of the sample and a span-to-depth ratio of 32.
Tensile properties of fibers, e.g. tensile strength and tensile modulus, were determined on multifilament yarns as specified in ASTM D885M, using a nominal gauge length of the fibre of 500 mm, a crosshead speed of 50%/min and Instron 2714 clamps, of type Fibre Grip D5618C. For calculation of the strength, the tensile forces measured are divided by the titre, as determined by weighing 10 metres of fibre; values in GPa for are calculated assuming the natural density of the polymer, e.g. for UHMWPE is 0.97 g/cm3.
The tensile properties, e.g. tensile strength and tensile modulus, of tapes and films, including the tensile strength, the tensile modulus and the elongation at break of pre-formed polymeric films are defined and determined as specified in ASTM D882 at 25° C., on tapes (if applicable obtained from films by slitting the films with a knife) of a width of 2 mm, using a nominal gauge length of the tape of 440 mm and a crosshead speed of 50 mm/min. If the tapes were obtained from slitting films, the properties of the tapes were considered to be the same as the properties of the films from which the tapes were obtained.
The thickness of a coating may be measured according to well-known techniques in the art, e.g. on a cross-section of the coated material with a microscope, e.g. scanning electron microscope.
The thickness of any one of the inventive products (including the coating if present) may be measured with a micrometer on an original location and on eight peripheral locations, said peripheral locations being within a radius of at most 0.5 cm from the original location, and averaging the values.
The thickness of a pre-formed polymeric film may be measured with a micrometer.
The melting temperature (also referred to as melting point) of a polymeric powder is measured according to ASTM D3418-97 by DSC with a heating rate of 20° C./min, falling in the melting range and showing the highest melting rate.
The melting temperature (also referred to as melting point) of a polymeric fiber or tape, e.g. a polyolefin fiber or tape, is determined by DSC on a power-compensation PerkinElmer DSC-7 instrument which is calibrated with indium and tin with a heating rate of 10° C./min. For calibration (two point temperature calibration) of the DSC-7 instrument about 5 mg of indium and about 5 mg of tin are used, both weighed in at least two decimal places. Indium is used for both temperature and heat flow calibration; tin is used for temperature calibration only. The furnace block of the DSC-7 is cooled with water, with a temperature of 4° C. This is done to provide a constant block temperature, resulting in more stable baselines and better sample temperature stability. The temperature of the furnace block should be stable for at least one hour before the start of the first analysis. The sample is taken such that a representative cross-sectional of adjoining peripheral fiber surfaces of adjacent fibers is achieved which may suitable be seen through light microscopy. The sample is cut into small pieces of 5 mm maximum width and length to achieve a sample weight of at least about 1 mg (+/−0.1 mg). The sample is put into an aluminum DSC sample pan (50 μl), which is covered with an aluminum lid (round side up) and then sealed. In the sample pan (or in the lid) a small hole must be perforated to avoid pressure build-up (leading to pan deformation and therefore worse thermal contact).
This sample pan is placed in a calibrated DSC-7 instrument. In the reference furnace an empty sample pan (covered with lid and sealed) is placed.
The following temperature program is run:
5 min. 40° C. (stabilization period)
40 up to 200° C. with 10° C./min. (first heating curve)
5 min. 200° C.
200 down to 40° C. (cooling curve)
5 min. 40° C.
40 up to 200° C. with 10° C./min. (second heating curve)
The same temperature program is run with an empty pan in the sample side of the DSC furnace (empty pan measurement).
Analysis of the first heating curve is used. The empty pan measurement is subtracted from the sample curve to correct for baseline curvature. Correction of the slope of the sample curve is performed by aligning the baseline at the flat part before and after the peaks (e.g. at 60 and 190° C. for UHMWPE). The peak height is the distance from the baseline to the top of the peak. For example in the case of UHMWPE, two endothermic peaks are expected for the first heating curve, in which case the peak heights of the two peaks are measured and the ratio of the peak heights determined.
For the calculation of the enthalpy of an endothermic peak transition prior to the main melting peak, the following procedure may be used. It is assumed that the endothermic effect is superimposed on the main melting peak. The sigmoidal baseline is chosen to follow the curve of the main melting peak, the baseline is calculated by the PerkinElmer Pyris™ software by drawing tangents from the left and right limits of the peak transition. The calculated enthalpy is the peak area between the small endothermic peak transition and the sigmoidal baseline. To correlate the enthalpy to a weight %, a calibration curve may be used.
Intrinsic Viscosity (IV) for polyethylene is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration.
Side chains in a polyethylene or UHMWPE sample is determined by FTIR on a 2 mm thick compression molded film by quantifying the absorption at 1375 cm-1 using a calibration curve based on NMR measurements (as in e.g. EP 0 269 151)
Tensile modulus of polymeric coatings for free-standing polymeric films was measured according to ASTM D-638(84) at 25° C. and about 50% RH.
Tensile strength of polymeric coatings for free-standing polymeric films was measured according to ASTM D882-10 at 23° C. and about 50% RH.
The electromagnetic properties, e.g. dielectric constant and dielectric loss, were determined for frequencies of between 1 GHz and 20 GHz with the well-known Split Post Dielectric Resonator (SPDR) technique. For frequencies of above 20 GHz, e.g. of between 20 GHz and 144 GHz, the Open Resonator (OR) technique was used to determine said electromagnetic properties, wherein a classical Fabry-Perot resonator setup having a concave mirror and a plane mirror was utilized. For both techniques plane samples were used, i.e. samples not having any curvature in the plane defined by their width and length. In the case of SPDR technique, the thickness of the sample was chosen as large as possible being limited only by the setup design, i.e. the maximum height of the resonator. For the OR technique, the thickness of the sample was chosen to be an integer of about λ/2, wherein λ is the wavelength at which the measurement is carried out. Since in the case of the SPDR technique, for each frequency at which the dielectric properties are measured a separate setup has to be utilized, the SPDR technique was carried out at the frequencies of 1.8 GHz; 3.9 GHz and 10 GHz. The setups corresponding to these frequencies are commercially available and were acquired from QWED (Poland) but are also sold by Agilent. The software delivered with these setups was used to compute the electromagnetic properties. For the OR technique, the setup was built in accordance with the instructions given in Chapter 7.1.17 of “A Guide to characterization of dielectric materials at RF and Microwave frequencies” by Clarke, R N, Gregory, A P, Cannell, D, Patrick, M, Wylie, S, Youngs, I, Hill, G, Institute of Measurement and Control/National Physical Laboratory, 2003, ISBN: 0904457389, and all the references cited in that chapter, i.e. references 1-6, and in particular reference [3] R N Clarke and C B Rosenberg, “Fabry-Perot and Open-resonators at Microwave and Millimetre-Wave Frequencies, 2-300 GHz”, J. Phys. E: Sci. Instrum., 15, pp 9-24, 1982.
The coefficient of variation of the loss tangent in a frequency interval is calculated by measuring at least 3, preferably at least 5, values of the loss tangent in the frequency interval, computing from these values the average loss tangent and the standard deviation of the loss tangent, and dividing said standard deviation to said average. The coefficient of variation is expressed in %.
Following standards can be used to characterize the mechanical properties of panels: ASTM C 393 for Core Shear by Flexure (3″×8″×thickness); ASTM C 297 for Flatwise Tensile□ (1″×1″×thickness); ASTM C 365 for Compression Strength (1″×1″×thickness); ASTM D 1781 for Climbing Drum Peel (3″×12″×thickness—requires 1″ overhang on both ends on one outer skin, plus one 3″×14″ piece of outer skin for calibration, face sheet ˜0.200″ thick); ASTM C 272 for Core Water Absorption (3″×3″×thickness); ASTM D 7136 for Compression after Impact (4″×6″×thickness). All standards require 5 specimens per test with the exception of ASTM D 1781, which requires 6 specimens. Tolerances are ±0.010″ with a core thickness of 0.500″ and a total thickness not exceeding 1″.

### Production of UHMWPE Tapes

In one embodiment, an ultrahigh molecular weight polyethylene with an intrinsic viscosity of 20 dl/g was mixed to become a 7 wt % suspension with decalin. The suspension was fed to an extruder and mixed at a temperature of 170° C. to produce a homogeneous gel. The gel was then fed through a slot die with a width of 600 mm and a thickness of 800 μm. After being extruded through the slot die, the gel was quenched in a water bath, thus creating a gel-tape. The gel tape was stretched by a factor of 3.8 after which the tape was dried in an oven consisting of two parts at 50° C. and 80° C. until the amount of decalin was below 1%. This dry gel tape was subsequently stretched in an oven at 140° C., with a stretching ratio of 5.8, followed by a second stretching step at an oven temperature of 150° C. to achieve a final thickness of 18 micrometer. The width of the tapes was 0.1 m and their tensile strength 440 MPa. For the purpose of the invention, the tapes manufactured in accordance with this embodiment will be referred to herein as gel-spun tapes.

In another embodiment a tape was manufactured by pressing a UHMWPE polymeric powder having an average molecular weight M_{w} of between 4 and 5 millions, IV of about 26 dl/g into a 0.2 mm thick tape. The pressing was carried out in a double belt press at a temperature of 125° C. and a pressure of about 0.02 GPa. The 0.2 mm thick tape was rolled by passing it through a pair of counter-rotating rollers having 100 mm in diameter and different peripheral speeds at 130° C. thereby forming a tape drawn 6 fold. The drawn tape was further drawn about 5 times into an oven at about 145° C. The resultant tape had a thickness of about 15 μm, a tensile strength of about 1.7 GPa, a tensile modulus of about 115 GPa and a width of about 80 mm. The process of this embodiment was similar with the process of EP 1 627 719 included herein by reference. For the purpose of the invention, the tapes manufactured in accordance with this embodiment will be referred to herein as solid-state tapes.

### EXAMPLE

Two multi-layered sheets were manufactured by consolidating under pressure and temperature a plurality of layers consisting essentially of the above solid-state UHMWPE tapes arranged to form a woven fabric. The layers were pressed together with a silicon based pre-formed film. The areal density of each of the multi-layered sheet was about 0.5 Kg/m².

The consolidated sheets were used as facings to manufacture a radome wall. The facings were separated by a core containing an R82.110 Alcan Airex® foam. An adhesive known as Exact® was used to enhance the connection between the facings and the core. The sandwich was pressed at 125 degrees for 1 h with 14.5 psi (about 1 bar).

The radome wall had excellent structural and electromagnetic properties. It was notable that by varying the facings' thicknesses the frequency response of the sandwich becomes more resonant. These resonances can be shifted to minimize transmission loss at target frequencies. The transmission efficiency (TE) at target frequencies 4.0 GHz, 39.5 GHz and 72 GHz was greater than 95% with very good broadband performance at angles of incidence up to 35°.

Figure illustrates that the sandwich of the Example meets the electromagnetic requirements for use in radome walls and demonstrates excellent transmission efficiency and broadband performance at multiple frequency bands. These excellent electromagnetic properties are complemented by excellent structural performance, in particular with regards to kinetic energy absorption and stiffness.

1. A radome wall comprising a composite panel of a sandwich type containing two facings separated by a core of an expanded polymeric material wherein the facings contain a multi-layered sheet comprising a consolidated plurality of layers, said layers containing polymeric tapes.

2. The radome wall of claim 1 wherein the tapes are solid-state tapes.

3. The radome wall of claim 1 wherein the tapes have a thickness of between 1 μm and 200 μm.

4. The radome wall of claim 1 wherein the tapes have an areal density of at most 160 g/m².

5. The radome wall of claim 1 wherein the polymeric tapes are polyolefin tapes.

6. The radome wall of claim 1 wherein the tapes are ultra high molecular weight polyethylene (UHMWPE) tapes.

7. The radome wall of claim 1 wherein the layers are matrix-free layers.

8. The radome wall of claim 1 wherein the polymeric tapes form a unidirectional fabric.

9. The radome wall of claim 1 wherein the polymeric tapes form a woven fabric.

10. The radome wall of claim 1 wherein the facings are coated.

11. The radome wall of claim 1 wherein the expanded polymeric material is a polymeric foam.

12. The radome wall of claim 11 wherein the foam is a closed-cell foam.

13. The radome wall of claim 1 wherein the expanded polymeric material is a polymeric foam and wherein the foam has cells having a diameter in the range of between 1 μm and 80 μm.

14. A radome comprising a radome wall of claim 1.

15. A radome-antenna system comprising the radome of claim 14 and an antenna device.
